(19) United States
(12) Patent Application Publication
(10) Pub. No.: US 2011/0066744 A1
(43) Pub. Date: Mar. 17, 2011

(54) Transitioning between Multiple Services in an MPEG Stream

(75) Inventors: Christopher S. Del Sordo, Souderton, PA (US); Terence R. Brogan, Norton, MA (US); Glen P. Goffin, Dublin, PA (US); Ernest G. Schmitt, Maple Glen, PA (US); Scott D. Sellers, Quakertown, PA (US)

(73) Assignee: GENERAL INSTRUMENT CORPORATION, Horsham, PA (US)

(21) Appl. No.: 12/561,898

(22) Filed: Sep. 17, 2009

(51) Int. Cl. G06F 15/16; H04N 7/26

(52) U.S. Cl. 709/231

(57) ABSTRACT

In a method for transitioning between multiple services in an MPEG stream, the MPEG stream including a pre-transition service and a post-transition service is received. In addition, a service transition point that identifies a location in the MPEG stream where the MPEG stream transitions from the pre-transition service having a first set of packet identifiers (PIDs) to the post-transition service having a second set of PIDs is detected for the MPEG stream and the second set of PIDs is mapped to have the same values as the first set of PIDs.

### BACKGROUND

Video content is known to be transported over MPEG streams, such as, MPEG-2 and MPEG-4 streams, to set top boxes from cable operators and other content providers. Each of the packets in the MPEG streams includes a header containing various information, such as, flags, a countdown field, and a 13 bit packet identifier (PID) field that identifies the portion of a packetized elementary stream (PES) for each of the packets. In addition, all of the packets in a PID stream have the same values, which may be assigned for each element of a PES, for instance for each frame of an audio elementary stream or each picture of a video elementary stream.

A program clock reference (PCR) is one of several auxiliary PID streams and contains samples of a 27 MHz clock used by the video and audio encoders and decoders. The PCR is carried by a PID stream with a PID called the PCR_PID. A program map table (PMT) is carried in another auxiliary PID stream and lists all the PID's that belong to the program and defines which PID streams contain which elements (video, audio channels, captions, PCR_PID).

The MPEG streams often include multiple services with packets for different programs multiplexed together. Consequently, the decoder has to be configured to select the packets of a program in order to decode a particular program. The decoder performs this function using a program association table (PAT) that lists the PID streams containing the PMT's for each of the programs. The PAT is carried in another auxiliary PID stream and is known to be carried in packets with a PID value of 0.

### SUMMARY

Disclosed herein is a method for transitioning between multiple sub-streams in an MPEG stream. In the method, the MPEG stream is received and a service transition point that identifies a location in the MPEG stream where the MPEG stream transitions from a pre-transition service having a first set of packet identifiers (PIDs) to a post-transition service having a second set of PIDs is detected. In addition, the second set of PIDs is mapped to have the same values as the first set of PIDs to substantially avoid interruption in the decoding of the MPEG stream between the pre-transition service and the post-transition service.

Also disclosed herein is a set top box having an input module configured to receive a SPTS comprising an MPEG stream, the MPEG stream including a pre-transition service and a post-transition service. The set top box also includes service transition point detector (STPD) module configured to detect a service transition point for the MPEG stream where the service transitions from the pre-transition service having a first set of PIDs to the post-transition service having a second set of PIDs. Further, the set top box includes a mapping module configured to map the second set of PIDs to have the same values as the first set of PIDs to substantially avoid interruption in the decoding of the MPEG stream between the pre-transition service and the post-transition service.

Further disclosed is a computer readable storage medium on which is embedded one or more computer programs. The one or more computer programs implement a method for transitioning between a pre-transition service and a post-transition service in an MPEG stream. The one or more computer programs includes a set of instructions for receiving the MPEG stream and detecting a service transition point that identifies a location in the MPEG stream where the MPEG stream transitions from the pre-transition service having a first set of PIDs to the post-transition service having a second set of PIDs. In addition, the one or more computer programs comprise a set of instructions for mapping the second set of PIDs to have the same values as the first set of PIDs to substantially avoid interruption in the decoding of the MPEG stream between the pre-transition service and the post-transition service.

Embodiments of the present invention provide a method and set top box (STB) for transitioning between a pre-transition service having a first set of PIDs and a post-transition service having a second set of PIDs in an MPEG stream in a substantially seamless manner. According to a particular embodiment, the transition is made substantially seamless by mapping the second set of PIDs to have the same values as the first set of PIDs. One result of this mapping is that decoding of the MPEG stream at the transition between the pre-transition service and the post-transition service is not interrupted because the PID values for the pre-transition service is identical to the PID values for the post-transition service.

### BRIEF DESCRIPTION OF THE DRAWINGS

Features of the present invention will become apparent to those skilled in the art from the following description with reference to the figures, in which:

FIG. 1 illustrates a simplified block diagram of a set top box, according to an embodiment of the invention;

FIG. 2 illustrates a simplified diagram of an MPEG stream composed of a pre-transition service and a post-transition service with a service transition point positioned in the transition between the pre-transition service and the post-transition service, according to an embodiment of the invention;

FIG. 3 illustrates a flow diagram of a method for transitioning between multiple services and an MPEG stream, according to an embodiment of the invention; and

FIG. 4 shows a block diagram of a computing apparatus configured to implement or execute one or more of the processes depicted in FIG. 3, according to an embodiment of the invention.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

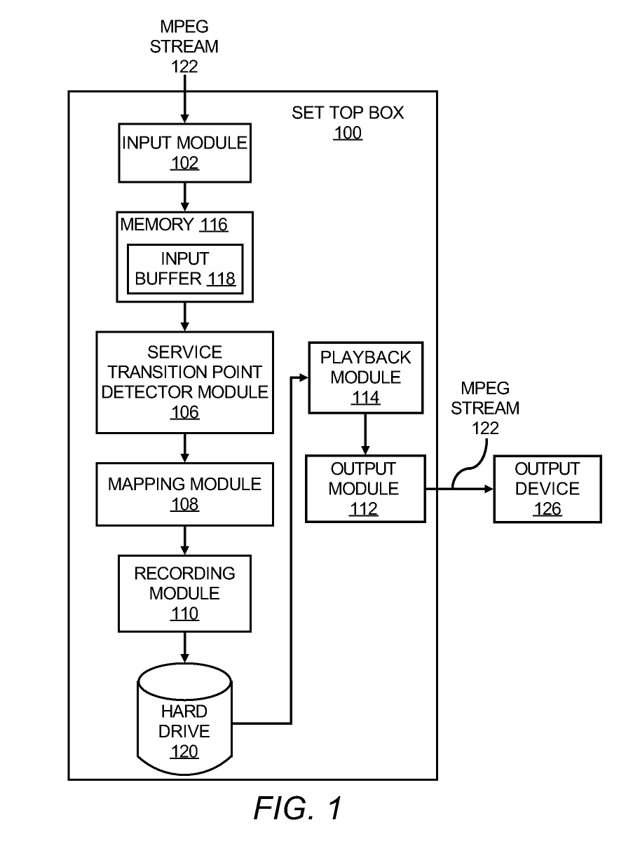

FIG. 1 illustrates a simplified block diagram of a set top box (STB) 100, according to an embodiment of the invention. It should be understood that the STB 100 depicted in FIG. 1 may include additional components and that some of the components described herein may be removed and/or modified without departing from a scope of the STB 100.

As depicted in FIG. 1, the STB 100 includes an input module 102, a service transition point detector (SPTD) module 106, a mapping module 108, a recording module 110, an output module 112, a playback module 114, a memory 116, and a hard drive 120. The modules 102-114 may comprise software modules, hardware modules, or a combination of software and hardware modules. Thus, in one embodiment, one or more of the modules 102-114 comprise circuit components. In another embodiment, one or more of the modules 102-114 comprise software code stored on a computer readable storage medium, which is executable by a processor.

The input module 102 is configured to receive an MPEG stream 122 and the output module 112 is configured to output an MPEG stream 124 in which a transition between multiple services in the output MPEG stream 124 has been made to be seamless. The MPEG stream may be based on MPEG-2, or on advanced video codec, for instance, MPEG-4 AVC (advanced video coding) or H.264.

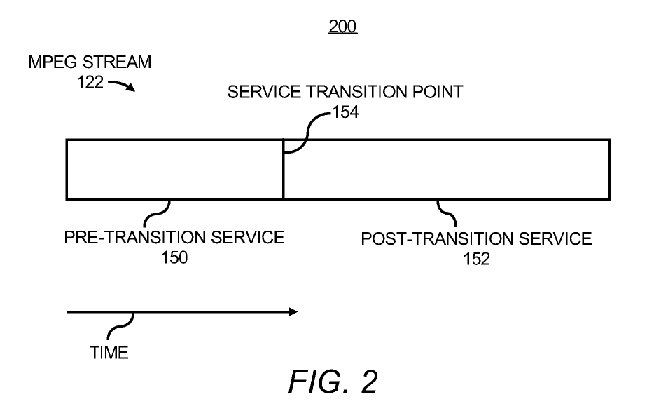

With reference now to FIG. 2, there is shown a simplified diagram 200 of an MPEG stream 122 composed of a pre-transition service 150 and a post-transition service 152 with a service transition point 154 positioned in the transition between the pre-transition service 150 and the post-transition service 152, according to an embodiment of the invention. According to an example, the pre-transition service 150 and the post-transition service 152 comprise different types of services, such as, for instance, programming content and advertising content, which may be received from different sources. As such, the pre-transition service 150 has a first set of PIDs that indicate the type of each packet in the MPEG stream 122 before the service transition point 154 and the post-transition service 152 has a second set of PIDs that indicate the type of each packet in the MPEG stream 122 after the service transition point 154, in which the first set of PIDs differs from the second set of PIDs. The STB 100 may receive the pre-transition service 150 and the post-transition service 152 from different sources, for instance, separate unicast or alternately separate multicast addresses, each having a separate unique set of PIDs.

The sets of PIDs are, for instance, 13-bit code in the transport packet header of each of the pre-transition service 150 and the post-transition service 152. By way of example, MPEG-2 transmits transport stream data in packets of 188 bytes. At the start of each packet is a PID that informs the input module 102 of the packet type. For instance, a PID value of 0 indicates that the packet contains a program association table (PAT) PID. All of the packets belonging to the same elementary stream have the same PID. An MPEG-2 stream may have multiple elementary streams, each indicated by a separate PID. For instance, an APID denotes packets belonging to the audio stream and a VPID denotes packets for the video stream. A program clock reference (PCR) PID is used to synchronize the video and audio packets. Where the MPEG-2 data stream is in multi-channel per carrier (MCPC) mode, the input module 102 determines which of the incoming packets are part of the current channel being watched.

In any regard, the input module 102 passes the incoming packets that are part of the current channel onto the STPD module 106 for further processing. The STPD module 106 is configured to detect the service transition point 154 wherein the MPEG stream 122 transitions from the pre-transition service 150 to the post-transition service 152. The service transition point 154 may comprise a video service transition point, metadata, a tune transition, or any application that results in a change of the service and set of PIDs. In addition, the SPDT module 106 is configured to detect the service transition point 154 from any of the previously mentioned elements.

In any regard, the STPD module 106 is configured to process the MPEG stream 122 to detect the location(s) of the service transition point(s) 154 in the MPEG stream 122. For instance, the STPD module 106 may parse the MPEG stream 122 in order to locate the service transition point(s) 154 while the decoded MPEG stream 123 is still contained within the input buffer 118.

Alternately, the STPD module 106 may receive an indication of the location of a service transition point 154 from a device external to the STB 100. For instance, in a switched digital video network (not shown), the external device may comprise, for instance, a groom and splice component (not shown) configured to identify and indicate the presence of the service transition point(s) 154 to the STPD module 106. In either instance, the STPD module 106 is configured to send an indication of the location of the service transition point 154 to the mapping module 108.

The mapping module 108 is configured to receive the service transition point 154 location from the STPD module 106. Further, the mapping module 108 is configured to map the first set of PIDs to the pre-transition service 150 and to map the second set of PIDs to the post-transition service 152. The first set of PIDs differs from the second set of PIDs as discussed above. Thus, as discussed in greater detail herein below, when the playback module 114 plays the MPEG stream 122, there is typically a noticeable interruption when transitioning from the pre-transition service 150 to the post-transition service 152. To substantially prevent a user from noticing that interruption, and according to an embodiment, the mapping module 108 is further configured to remap the second set of PIDs to have the same values as the first set of PIDs. The remapped values are thereafter transferred to the recording module 110 with the post-transition service 152.

The recording module 110 is configured to record the mapped first set of PIDs and the remapped second set of PIDs in the hard drive 120. Further, the recording module 110 is configured to record the first set of PIDs with the pre-transition service 150 to the hard drive 120. In addition, the recording module 110 is configured to record the remapped set of PIDs of the post-transition service 152 to the hard drive 120. In one regard, because the remapped second set of PIDs of the post-transition service 152 have the same values the first set of PIDs of the pre-transition service 150, playback of the transition 154 between the pre-transition service 150 and the post-transition service 152 is substantially seamless.

The recording module 110 may begin recording at a time specified by the STB 100, for instance when the end user presses a record button (not shown) on the STB 100. According to an embodiment, the recording module 110 may record the first set of PIDs of the pre-transition service 150 substantially concurrently with the STB 100 communicating the MPEG stream 122 to the playback module 114. The recording module 110 may also update a program association table (PAT) and a program map table (PMT) for the post-transition service 152 with the substituted values for the second set of PIDs.

When playback is initiated from the STB 100, the playback module 114 is configured to play the recorded MPEG stream 122 beginning at the pre-transition service 150, which may comprise, for instance, a broadcast television program. Because the second set of PIDs of the post-transition service 152 have been made substituted with the first set of PIDs of the pre-transition service 150, the playback module 114 is able to substantially seamlessly play the MPEG stream 122 without interruption at the service transition point 154. By contrast, the playback of recorded MPEG streams in a conventional set top box is typically interrupted at the service transition point 154. This occurs because the change of values of the first set of PIDs and the second set of PIDs resets a variety of hardware. More particularly, the audio decoder, the video decoder, and the PCR time clock decoders reroute with a change in the PID values causing an interruption to the MPEG stream, which is analogous to the interruption occurring when a conventional set top box tunes to a different channel. The interruption caused by the rerouting of decoders in a conventional set top box may clip a portion of the available time for a targeted advertisement in a targeted advertising system.

According to another embodiment, the output device 126 comprises a digital video recorder, a personal computer, a mobile computing device, a personal digital assistant, a cellular telephone, another set-top box, etc. As such, for instance, the output device 126 may be a network device and the STB 100 may remap sets of PIDs for a local set-top or for a network, such as a multi-room DVR. In one regard, the remapped PIDs are used by the output device 126 during playback of the MPEG stream to thus substantially avoid interruption in the decoding of the MPEG stream, which may be performed at the STB 100 or the output device 126, between a pre-transition service and a post-transition service in the MPEG stream. In addition, the communication from the set-top box 100 to the output device 126 may also be through an MPEG stream that is either encoded or decoded.

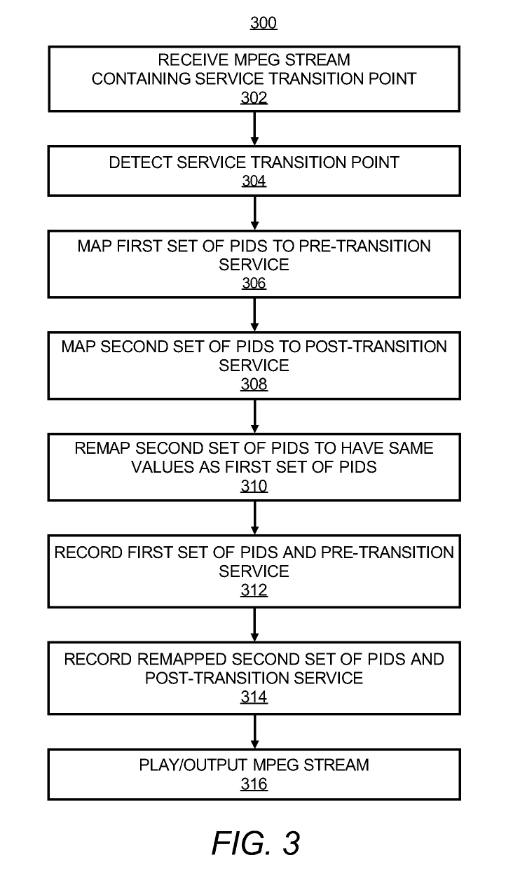

Turning now to FIG. 3, there is illustrated a flow diagram of a method 300 for transitioning between multiple services in an MPEG stream, according to an embodiment of the invention. It should be understood that the method 300 depicted in FIG. 3 may include additional steps and that some of the steps described herein may be removed and/or modified without departing from a scope of the method 300.

The description of the method 300 is made with particular reference to the STB 100 depicted in FIG. 1 and thus makes particular reference to the elements contained in the STB 100. It should however, be understood that the method 300 may be implemented in an apparatus that differs from the STB 100 without departing from a scope of the method 300.

At step 302, the set top box 100 receives the MPEG stream 122 at the input module 102. The MPEG stream 122 contains the service transition point 154 where the pre-transition service 150 with the first set of PIDs transitions to the post-transition service 152 with the second set of PIDs. In addition, at least a portion of the MPEG stream 122 may be stored in the buffer 118 as the MPEG stream 122 is received through the input module 102.

At step 304, the STPD module 106 identifies the location of a service transition point 154 in the decoded MPEG stream 123. The STPD module 106 may parse the decoded MPEG stream 123 to locate the service transition point 154. Alternately, the STPD module 106 may receive an indication that of service transition point 154 location from a device external to the STB 100 as discussed above.

At step 306, the mapping module 108 receives the indication of the service transition point 154 location and maps the first set of PIDs to the pre-transition service 150. In addition, at step 308, the mapping module 108 maps the second set of PIDs to the post-transition service 152.

At step 310, the mapping module 108 remaps the second set of PIDs to have the same values as the first set of PIDs.

At step 312, the recording module 110 records the first set of PIDs and the pre-transition service 150 on the hard drive 120. The recording of the MPEG stream 122 may be initiated at any time that the input module 102 is receiving the MPEG stream 122.

At step 314, the recording module 110 stores the remapped second set of PIDs and the post-transition service 152 on the hard drive 120.

At step 316, the playback module 114 either plays the MPEG stream 122 or the MPEG stream 122 is outputted to an output device 126 as discussed above. The playback module 114 may comprise a part of the STB 100. Alternately, the playback module 114 may comprise a part of the output device 126. In any regard, during playback, the remapped second set of PIDs of the post-transition service 152 have the same values as the first set of PIDs of the pre-transition service 150. As such, the playback module 114 (or the output device 126) seamlessly plays back the MPEG stream 122 during the transition between the pre-transition service 150 and the post-transition service 152 because the playback module 114 does not detect a different set of PIDs during that transition. In effect, the playback module 114 may not even be aware of the service transition point 154 because the playback module 114 (or the output device 126) does not detect a change in the set of PIDs.

Through implementation of the method and set top box (STB) disclosed herein, the transition between a pre-transition service having a first set of PIDs and a post-transition service having a second set of PIDs in an MPEG stream is made to be substantially seamless by mapping the second set of PIDs to have the same values as the first set of PIDs. One result of this mapping is that decoding of the MPEG stream at the transition between the pre-transition service and the post-transition service is not interrupted because the PID values for the pre-transition service is identical to the PID values for the post-transition service.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

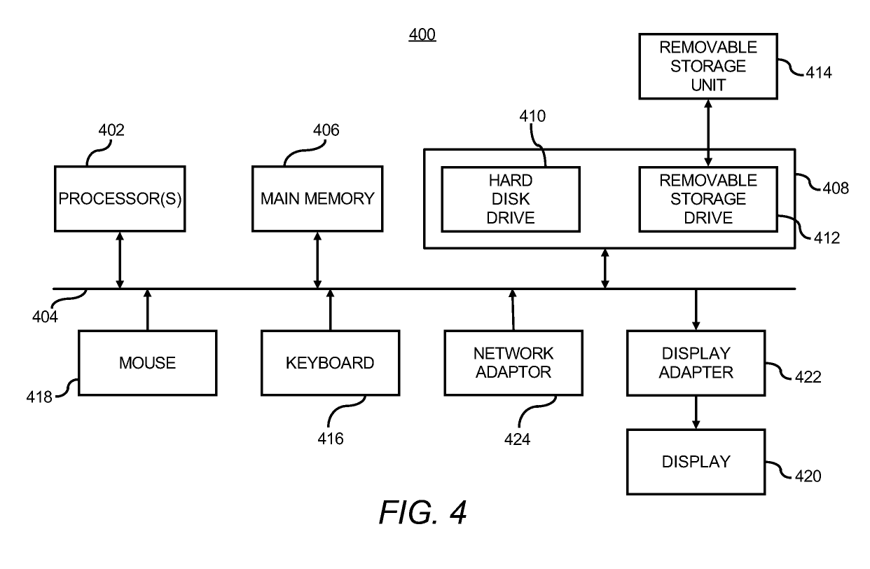

FIG. 4 illustrates a block diagram of a computing apparatus 400 configured to implement or execute one or more of the processes depicted in FIG. 3, according to an embodiment. It should be understood that the illustration of the computing apparatus 400 is a generalized illustration and that the computing apparatus 400 may include additional components and that some of the components described may be removed and/or modified without departing from a scope of the computing apparatus 400.

The computing apparatus 400 includes a processor 402 that may implement or execute some or all of the steps described in one or more of the processes depicted in FIG. 3. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for one or more of the processes depicted in FIG. 3 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A method for transitioning between multiple services in an MPEG stream, the method comprising:
receiving a single program transport stream (SPTS) comprising the MPEG stream, said MPEG stream including a pre-transition service and a post-transition service;
detecting a service transition point for the MPEG stream, wherein the detected service transition point identifies a location in the MPEG stream where the MPEG stream transitions from the pre-transition service having a first set of packet identifiers (PIDs) to the post-transition service having a second set of PIDs; and
mapping the second set of PIDs to have the same values as the first set of PIDs to substantially avoid interruption in the decoding of the MPEG stream between the pre-transition service and the post-transition service.

2. The method of claim 1, further comprising:
recording the MPEG stream, and wherein detecting the service transition point and mapping the second set of PIDs further comprises detecting the service transition point and mapping the second set of PIDs from the recorded MPEG stream.

3. The method of claim 2, further comprising:
playing the recorded MPEG stream with the remapped second set of PIDs to produce a seamless transition from the pre-transition service to the post-transition service during playback of the recorded MPEG stream.

4. The method of claim 1, wherein detecting the service transition point and mapping the second set of PIDs further comprises detecting the service transition point and mapping the second set of PIDs during receipt of the MPEG stream.

5. The method of claim 1, further comprising updating a program association table for the post-transition service and a program map table for the post-transition service with the remapped values for the second set of PIDs.

6. The method of claim 1, wherein the pre-transition service comprises programming content and the post-transition service comprises targeted advertising content.

7. The method of claim 1, further comprising:
storing the MPEG stream and the remapped second set of PIDs of the post-transition service on a hard drive.

8. The method of claim 1, wherein the pre-transition service is received from a first source and wherein the post-transition service is received from a second source, and wherein the first source differs from the second source.

9. The method of claim 1, wherein detecting the service transition point further comprises detecting the service transition point from at least one of metadata and a tune transition point in the MPEG stream.

10. The method of claim 1, wherein detecting the service transition point further comprises receiving an indication of the location of the service transition point from an apparatus external to a module for detecting the service transition point.

11. The method of claim 1, further comprising:
outputting the MPEG stream with the mapped second set of PIDs to at least one of a digital video recorder (DVR), a personal computer, and a set top box.

12. A set top box comprising:
an input module configured to receive a single program transport stream (SPTS) comprising an MPEG stream, said MPEG stream including a pre-transition service and a post-transition service;
a service transition point detector (STPD) module configured to detect a service transition point in the MPEG stream where the service transitions from the pre-transition service having a first set of PIDs to the post-transition service having a second set of PIDs; and
a mapping module configured to map the second set of PIDs to have the same values as the first set of PIDs to substantially avoid interruption in the decoding of the MPEG stream between the pre-transition service and the post-transition service.

13. The set top box of claim 12, further comprising a recording module configured to update a program map table (PMT) for the post-transition service and a program association table (PAT) for the post-transition service with the remapped values for the second set of PIDs.

14. The set top box of claim 12, further comprising a playback module configured to play the MPEG stream with the second set of PIDs having the same values as the first set of PIDs.

15. The set top box of claim 12, further comprising and output module configured to output the MPEG stream with the mapped second set of PIDs to at least one of a digital video recorder, a personal computer, and a set-top box.

16. The set top box of claim 12, wherein the pre-transition service comprises programming content and the post-transition service comprises targeted advertising content.

17. The set top box of claim 12, wherein the STPD module is further configured to detect the service transition point directly from the decoded MPEG stream.

18. The set top box of claim 12, wherein the STPD module is further configured to receive an indication of a location of the service transition point from an apparatus external to the STPD module.

19. A computer readable storage medium on which is embedded one or more computer programs, said one or more computer programs implementing a method for transitioning between a pre-transition service and a post-transition service in an MPEG stream, said one or more computer programs comprising a set of instructions for:
receiving the MPEG stream;
detecting a service transition point for the MPEG stream, wherein the detected service transition point identifies a location in the MPEG stream where the MPEG stream transitions from the pre-transition service to the post-transition service, wherein the pre-transition service has a first set of packet identifiers (PIDs) and the post-transition service has a second set of PIDs; and
mapping the second set of PIDs to have the same values as the first set of PIDs to substantially avoid interruption in the decoding of the MPEG stream between the pre-transition service and the post-transition service.

20. The computer readable storage medium of claim 19, further comprising a set of instructions for:
updating a program association table and a program map table for the post-transition service with the remapped values for the second set of PIDs.
